(19) United States
(12) Patent Application Publication
(10) Pub. No.: US 2026/0294719 A1
(43) Pub. Date: Oct. 1, 2026

(54) SYSTEMS FOR CONNECTING AN INCUBATOR TO A PATIENT TRANSPORT DEVICE

(71) Applicant: TECHNOLOGIES CGC INC., Quebec (CA)

(72) Inventors: Mathieu CHOUINARD, Quebec (CA); Carl BOUCHARD, Quebec (CA)

(21) Appl. No.: 19/097,066

(22) Filed: Apr. 1, 2025

(51) Int. Cl. A61G 11/00

(52) U.S. Cl. CPC A61G 11/00; A61G 2203/80

(57) ABSTRACT

An incubator interface configured to removably attach an incubator to a patient transport device. The incubator interface includes a body having a support surface for supporting the incubator. An incubator coupling assembly is moveable between an incubator coupled configuration, in which the incubator can be coupled to the body, and an incubator uncoupled configuration, in which the incubator can be removed from the body. The incubator coupling assembly includes an incubator coupling component and an incubator actuator operably connected to the incubator coupling component. A transport coupling assembly is moveable between a transport coupled configuration, in which the body of the incubator interface can be coupled to the patient transport device, and a transport uncoupled configuration, in which the body can be removed from the patient transport device. The transport coupling assembly includes a transport coupling component and a transport actuator operably connected to the transport coupling component.

### FIELD OF TECHNOLOGY

The present technology relates to systems for connecting an incubator to a patient transport device.

### BACKGROUND

In neonatal care, the safe and efficient transport of fragile newborns is critical. Transport systems for neonates typically utilize incubators or other life-sustaining medical equipment designed to provide stability, maintain environmental control, and ensure continuous access for personnel to administer care during transport.

Current neonatal transport systems often involve permanently or semi-permanently coupling an incubator to a patient transport device. This makes transferring the incubator between different transport devices, such as from an ambulance stretcher to a hospital stretcher, a time-consuming and operationally challenging process.

To address these challenges, specialized neonatal transport devices have been developed to facilitate the efficient connection and removal of incubators. These specialized transport devices are tailored to accommodate specific incubators and associated neonatal equipment, allowing for easier coupling and decoupling. However, this significantly increases capital costs for medical centers as they must invest in multiple specialized neonatal transport devices designed for specific use cases, such as in-hospital transport, in-ambulance transport, and/or air transport.

There is therefore a need for systems which address at least some of these drawbacks.

### SUMMARY

It is an object of the present technology to ameliorate at least some of the inconveniences present in the prior art.

According to one aspect of the present technology, there is provided a system for connecting an incubator to a patient transport device, The system comprises an incubator interface having a body having a support surface for supporting the incubator, the body defining a body plane; an incubator coupling assembly moveable between a incubator coupled configuration, in which the incubator can be coupled to the body, and an incubator uncoupled configuration, in which the incubator can be removed from the body, the incubator coupling assembly including: an incubator coupling component for removably coupling the incubator to the body; and an incubator actuator operably connected to the incubator coupling component for actuating the incubator coupling component to selectively couple the incubator to the body; and a transport coupling assembly movable between a transport coupled configuration, in which the body of the incubator interface can be coupled to the patient transport device, and a transport uncoupled configuration, in which the body can be removed from the patient transport device, the transport coupling assembly including: a transport coupling component for removably coupling the body to the patient transport device; and a transport actuator operably connected to the transport coupling component for actuating the transport coupling unit to selectively couple the body to the patient transport device.

In some embodiments, the incubator coupling component is configured to allow coupling and uncoupling of the incubator is in a direction perpendicular to the body plane.

In some embodiments, the incubator actuator is moveable in a plane parallel to the body plane.

In some embodiments, the incubator coupling component is configured to prevent movement of the incubator in a direction substantially parallel to the body plane.

In some embodiments, the incubator coupling component is configured to move in a direction substantially parallel to the support surface between the incubator coupled and uncoupled configurations.

In some embodiments, the incubator coupling component includes an arm that is configured to engage with a portion of the incubator when the incubator is disposed on the support surface and when the incubator coupling assembly is moved into the incubator coupled configuration, the arm being spaced from the support surface of the body by a neck.

In some embodiments, the incubator coupling component includes a plurality of incubator coupling components.

In some embodiments, the incubator coupling assembly is configured such that actuation of the incubator actuator causes the plurality of incubator coupling components to move simultaneously to selectively couple the incubator to the body.

In some embodiments, the incubator coupling assembly is configured such that actuation of the incubator actuator causes at least some of the plurality of incubator coupling components to move away from each other or towards each other.

In some embodiments, the plurality of incubator coupling components includes: a first pair of incubator coupling components longitudinally aligned with one another along a first longitudinal axis of the body; and a second pair of incubator coupling components longitudinally aligned with one another along a second longitudinal axis of the body, the second longitudinal axis being substantially parallel to the first longitudinal axis.

In some embodiments, each incubator coupling component of the first pair of incubator coupling components have the same orientation as one another; and each incubator coupling component of the second pair of incubator coupling components have the same orientation as one another.

In some embodiments, the first pair of incubator coupling components are oriented opposite to the second pair of incubator coupling components.

In some embodiments, the first pair of incubator coupling components are moveable relative to the body in a first direction along the first longitudinal axis; and the second pair of incubator coupling components are moveable relative to the body in a second direction along the second longitudinal axis, the second direction being opposite to the first direction.

In some embodiments, the incubator linkage assembly includes: a first linkage aligned with the first longitudinal axis and connected to the first pair of incubator coupling components and the incubator actuator; a second linkage aligned with the second longitudinal axis and connected to the second pair of incubator coupling components and the incubator actuator; and the first linkage and the second linkage move opposite to one another responsive to actuation of the incubator actuator.

In some embodiments, the incubator linkage assembly includes: a first linkage configured to move substantially along the first longitudinal axis and connected to the first pair of incubator coupling components and the incubator actuator; a second linkage configured to move substantially along the second longitudinal axis and connected to the second pair of incubator coupling components and the incubator actuator; and the first linkage and the second linkage move opposite to one another responsive to actuation of the incubator actuator.

In some embodiments, the first pair of incubator coupling components and the second pair of incubator coupling components have the same orientation as one another.

In some embodiments, the first pair of incubator coupling components are moveable relative to the body in a first direction along the first longitudinal axis; and the second pair of incubator coupling components are moveable relative to the body in a second direction along the second longitudinal axis, the second direction being the same as the first direction.

In some embodiments, the incubator linkage assembly includes: a first linkage substantially aligned with the first longitudinal axis and connected to the first pair of incubator coupling components and the incubator actuator; a second linkage substantially aligned with the second longitudinal axis and connected to the second pair of incubator coupling components and the incubator actuator; and the first linkage and the second linkage move in the same direction responsive to actuation of the incubator actuator.

In some embodiments, the incubator linkage assembly includes: a first linkage configured to move substantially along the first longitudinal axis and connected to the first pair of incubator coupling components and the incubator actuator; a second linkage configured to move substantially along the second longitudinal axis and connected to the second pair of incubator coupling components and the incubator actuator; and the first linkage and the second linkage move in the same direction responsive to actuation of the incubator actuator.

In some embodiments, the incubator interface further includes at least one positioning member extending from, or defined in, the support surface and configured to engage with the incubator when the incubator is disposed on the support surface at a predetermined position.

In some embodiments, the incubator coupling assembly further includes an incubator biasing member for biasing the incubator coupling component to the incubator coupled configuration.

In some embodiments, the incubator coupling assembly further includes an incubator retention mechanism for retaining the incubator coupling assembly in one of the incubator coupled configuration and the incubator uncoupled configuration.

In some embodiments, the incubator actuator includes an incubator actuator arm; and the incubator retention mechanism includes: an incubator retention groove defined in the incubator actuator arm having: a first end corresponding to the incubator coupled configuration; and a second end corresponding to the incubator uncoupled configuration; and an incubator retention pin connected to the body and slidably received in the incubator retention groove.

In some embodiments, the incubator retention mechanism further includes an incubator retention biasing member for biasing the incubator retention mechanism towards the one of the incubator coupled configuration and the incubator uncoupled configuration.

In some embodiments, the transport coupling component extends downwardly from the body.

In some embodiments, the transport coupling component includes: a first transport coupling component connected to the body; and a second transport coupling component removably connected to the first transport coupling component, wherein the second transport coupling component is configured to be removably connected to the patient transport device.

In some embodiments, the second transport coupling component is configured to move in an installation direction to removably couple with the first transport coupling component, the installation direction being perpendicular to the body plane.

In some embodiments, the first transport coupling component includes a female coupling element; and the second transport coupling component includes a male coupling element.

In some embodiments, the second transport coupling component includes a clamp portion for connecting to the patient transport device.

In some embodiments, the first transport coupling component includes: a first engagement arm; and a second engagement configured, the first and second engagement arms being configured to move to engage the male coupling element of the second transport coupling component.

In some embodiments, when the transport coupling assembly is in the transport coupled configuration: the first engagement arm engages a first side of the male coupling element; the second engagement arm engages a second side of the male coupling element; and the first side and the second sides are opposite to one another.

In some embodiments, the first engagement arm and the second engagement arm are configured to move towards and away from one another.

In some embodiments, when the transport coupling assembly is moved to the transport coupled configuration, the first engagement arm and the second engagement arm move toward one another; and when the transport coupling assembly is moved to the transport uncoupled configuration, the first engagement arm and the second engagement arm move away from one another.

In some embodiments, the first transport coupling component further includes a rod operably coupled to the transport actuator and the first and second engagement arms, such that the transport actuator causes rotation of the rod cause the first and second engagement arms to move towards and away from one another.

In some embodiments, when the rod is rotated in a first rotational direction, the first engagement arm and the second engagement arm move towards one another; and when the rod is rotated in a second rotational direction, the second rotational direction being opposite the first rotational direction, the first engagement arm and the second engagement arm move away from one another.

In some embodiments, the first transport coupling component further includes: a first engagement arm biasing member operably connected to the first engagement arm; and a second engagement arm biasing member operably connected to the second engagement arm, the first and second engagement arm biasing members being configured to bias the first and the second engagement arms toward one another.

In some embodiments, the transport assembly further includes a transport linkage assembly operably connected to the transport actuator and the rod.

In some embodiments, linear movement of the transport linkage assembly causes rotational movement of the rod.

In some embodiments, the transport assembly further includes a transport retention mechanism for retaining the transport coupling assembly in one of the transport coupled configuration and the transport uncoupled configuration.

In some embodiments, the transport actuator includes a transport actuator arm; and the transport retention mechanism includes: a transport retention groove defined in the transport actuator arm having: a first end corresponding to the transport coupled configuration; and a second end corresponding to the transport uncoupled configuration; and a transport retention pin connected to the body and slidably received in the transport retention groove.

In some embodiments, the transport retention mechanism further includes a transport retention biasing member for biasing the transport retention mechanism towards the one of the transport coupled configuration and the transport uncoupled configuration.

In some embodiments, the incubator actuator is disposed at a first end of the body; and the transport actuator is disposed at a second end of the body.

In some embodiments, the incubator actuator moves in a first actuator direction to actuate the incubator coupling assembly to the incubator coupled configuration; and the transport actuator moves in a second actuator direction to actuate the transport coupling assembly to the transport coupled configuration, the first actuator direction being opposite to the second actuator direction.

In some embodiments, the incubator actuator moves in the first actuator direction along a first actuator longitudinal axis; and the transport actuator moves in the second actuator direction along a second actuator longitudinal axis parallel to the first actuator longitudinal axis.

In some embodiments, the patient transport device is a stretcher.

In some embodiments, the patient transport device is an air transport cot.

In some embodiments, the system further comprises the incubator.

In some embodiments, the system further comprises a neonatal medical device connected to the incubator interface.

In the context of the present application, unless expressly provided otherwise, the words “first”, “second”, “third”, etc. have been used as adjectives only for the purpose of allowing for distinction between the nouns that they modify, and not for the purpose of describing any particular relationship between those nouns.

It must be noted that, as used in this specification and the appended claims, the singular form “a”, “an”, and “the” include plural referents unless the context clearly dictates otherwise.

As used herein, the term “and/or” is to be taken as specific disclosure of each of the two specified features or components with or without the other. For example, “A and/or B” is to be taken as specific disclosure of each of (i) A, (ii) B, and (iii) A and B, just as if each is set out individually herein.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, front, left side of a system comprising an incubator interface coupling an incubator and neonatal medical devices to a stretcher in accordance with an embodiment of the present technology;

FIG. 2 is a perspective view taken from a top, front, left side of the incubator interface of FIG. 1 coupled to the stretcher with the incubator and the neonatal medical devices removed;

FIG. 3 is a perspective view taken from a top, front, left side of the incubator interface of FIG. 1 with an incubator coupling assembly of the system in a coupled configuration;

FIG. 4 is a perspective view taken from a top, rear, right side of the incubator interface of FIG. 1 with the incubator coupling assembly of the system in an uncoupled configuration;

FIG. 5 is a perspective view taken from a top, rear, right side of an incubator coupling component of the incubator coupling assembly of FIGS. 3 and 4;

FIG. 6 is a perspective view taken from a top, front, left side of the incubator interface of FIG. 1 with a support surface of the incubator interface being removed;

FIG. 7 is a bottom plan view of the incubator interface of FIG. 1 with the incubator coupling assembly and a transport coupling assembly in a coupled configuration;

FIG. 8 is a bottom plan view of the incubator interface of FIG. 1 with the incubator coupling assembly and the transport coupling assembly in an uncoupled configuration;

FIG. 9 is a top, front, left side of an incubator interface having an alternative embodiment of the incubator coupling assembly;

FIG. 10 is a close up view of an incubator actuator of the incubator coupling assembly of the incubator interface of FIG. 7;

FIG. 11 is a close up view of the incubator actuator of the incubator coupling assembly of the incubator interface of FIG. 8;

FIG. 12 is a perspective view taken from a top, front, left side of the incubator interface of FIG. 1 with the transport coupling assembly in the coupled configuration;

FIG. 13 is a top, front, left side exploded perspective view of a transport coupling component of the system of FIG. 1;

FIG. 14 is a close up bottom plan view of the incubator interface of FIG. 1 with the transport coupling assembly in a coupled configuration;

FIG. 15 is a cross-sectional view of the transport coupling component of FIG. 12, taken along line A-A of FIG. 12;

FIG. 16 is a close-up bottom plan view of the incubator interface of FIG. 1 with the transport coupling assembly in an uncoupled configuration;

FIG. 17 is a cross-sectional view of the transport coupling component of FIG. 12, taken along line A-A of FIG. 12;

FIG. 18 is a perspective view taken from a top, front, right side of an alternative embodiment of a portion of a transport coupling component; and

FIG. 19 is a perspective view taken from a top, front, left side of a system comprising an incubator interface having an incubator and neonatal medical devices coupled to the incubator interface and the incubator interface being coupled to an air transport cot.

It should be noted that, unless otherwise explicitly specified herein, the drawings are not necessarily to scale.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of "including", "comprising", or "having", "containing", "involving" and variations thereof herein, is meant to encompass the items listed thereafter as well as, optionally, additional items. In the following description, the same numerical references refer to similar elements.

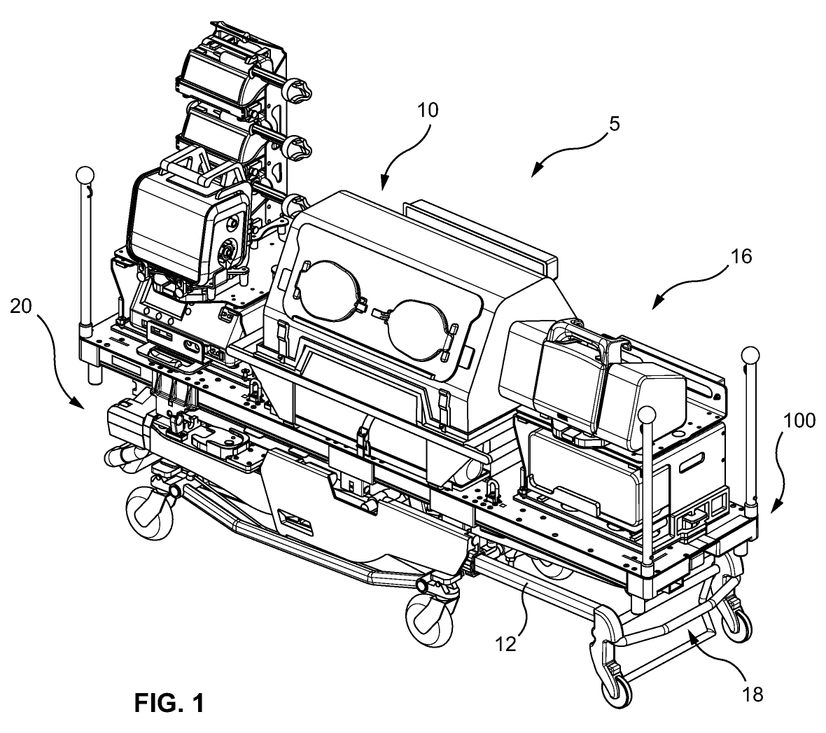

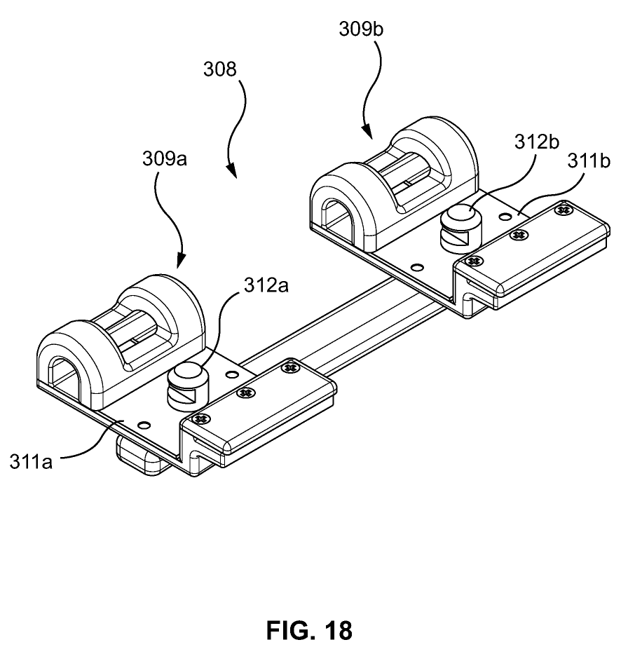

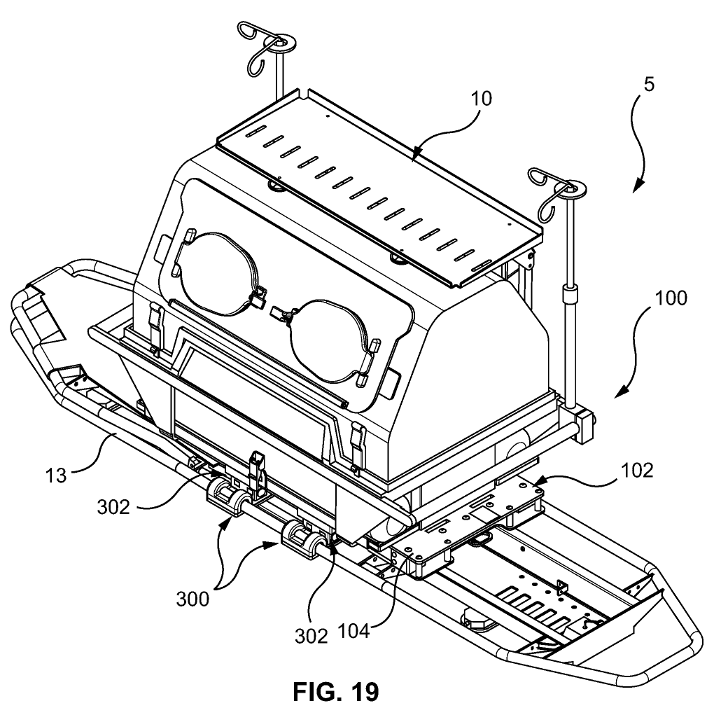

With reference to FIGS. 1-17, there is provided a system 5 for removably connecting a medical device, such as a neonatal incubator 10, to a patient transport device 12. The system 5 comprises an incubator interface 100. The incubator interface 100 is configured to removably couple to the incubator 10. The incubator interface 100 is further configured to removably couple to the patient transport device 12. Thus, the incubator interface 100 acts as an intermediate or a connector between the incubator 10 and the patient transport device 12. In this embodiment, the patient transport device 12 is a stretcher 12. However, it is contemplated that the patient transport device 12 may differ in other embodiments. For instance, as described in further detail below with reference to FIGS. 18 and 19, the patient transport device 12 may be an air transport cot 13. Alternatively, the patient transport device 12 may comprise part of a vehicle such as a support surface in an ambulance or a helicopter.

The incubator interface 100 includes a body 102 defining a body plane. The body 102 has a support surface 104 for supporting the incubator 10. In this embodiment, the support surface 104 spans the full length and width of the stretcher 12. As depicted in FIG. 1, the support surface 104 is further configured to support medical equipment 16 such as associated neonatal medical equipment and support systems, including but not limited to one or more of a ventilator, an infusion pump, a syringe pump, a monitoring device, and/or vital monitoring equipment. It is contemplated that the size of the support surface 104 may vary in other embodiments. For example, in alternative embodiments, the support surface 104 may have a length and a width substantially similar to that of the incubator 10 the support surface 104 is supporting.

The system 5 includes an incubator coupling assembly 200 for coupling the incubator 10 to the incubator interface 100. The incubator coupling assembly 200 is moveable between an incubator coupled configuration, in which the incubator can be coupled to, and retained on, the body 102 of the incubator interface 100, and an incubator uncoupled configuration, in which the incubator 10 can be removed from the body 102 of the incubator interface 100.

The system 5 further includes a transport coupling assembly 300 for coupling the incubator interface 100 to the stretcher 12. The transport coupling assembly 300 is moveable between a coupled transport configuration, in which the body 102 of the incubator interface 100 can be coupled to the stretcher 12, and a transport uncoupled configuration, in which the body 102 of the incubator interface 100 can be removed from the stretcher 12.

The incubator coupling assembly 200 and the transport coupling assembly 300 are designed to operate independently from one another, providing enhanced flexibility for the incubator interface 100. For example, a user can uncouple the incubator interface 100 from the stretcher 12 without interfering with the coupling between the incubator 10 and the incubator interface 100. This allows the incubator interface 100, along with the incubator 10, to be seamlessly and efficiently transferred from the stretcher 12 to another patient transport device. Similarly, the user can uncouple the incubator 10 from the incubator interface 100 without interfering with the coupling between the incubator interface 100 and the stretcher 12. This allows the user to modify the neonatal medical equipment 16 and/or support systems coupled to the incubator interface 100 as needed without requiring the incubator interface 100 to be uncoupled from the stretcher 12.

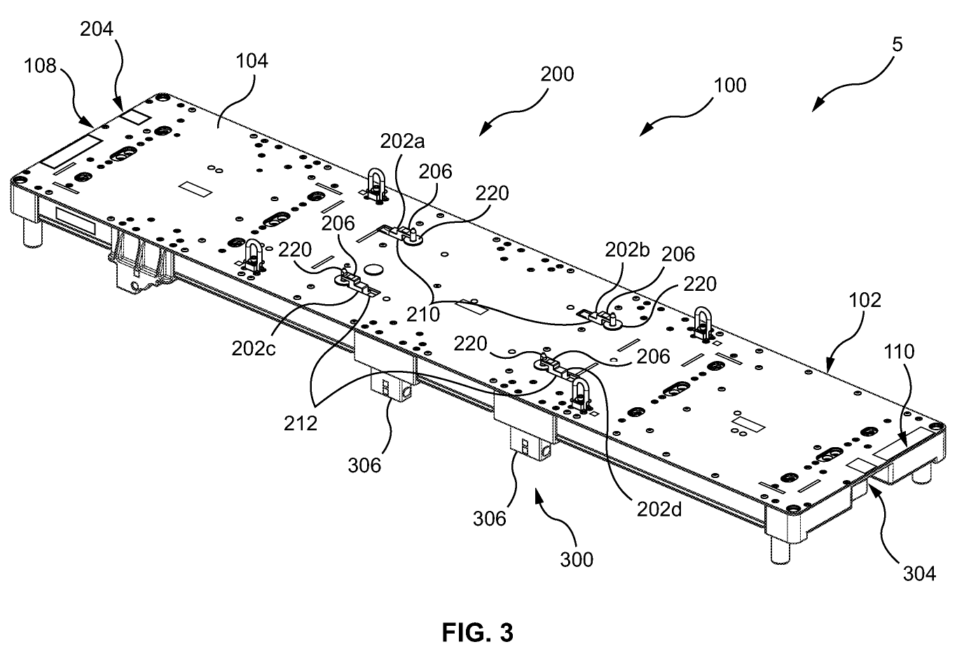

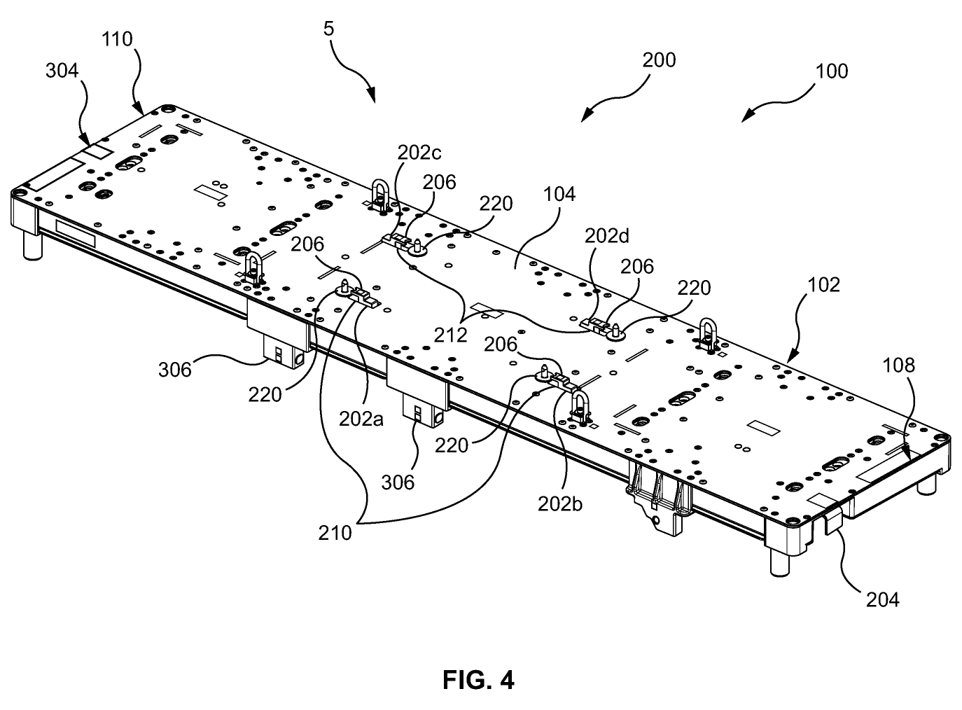

Referring to FIGS. 3-11, the incubator coupling assembly 200 will be described in detail. As described above, the incubator coupling assembly 200 is moveable between the incubator coupled configuration (as depicted in FIG. 3) and the incubator uncoupled configuration (as depicted in FIG. 4). The incubator coupling assembly 200 includes an incubator coupling component 202 for removably coupling the incubator 10 to the body 102 of the incubator interface 100. The incubator coupling assembly 200 further includes an incubator actuator 204, operably connected to the incubator coupling component 202, to actuate the incubator coupling component 202 to selectively couple the incubator 10 to the body 102.

In this embodiment, the incubator coupling assembly 200 includes four incubator coupling components 202a, 202b, 202c, 202d. It is contemplated that the number of incubator coupling components 202 is not limiting, and in alternative embodiments, the incubator coupling assembly 200 may include any number of incubator coupling components 202. It is noted that each of the incubator coupling components 202a, 202b, 202c, 202d have the same configuration, and thus for clarity, only the incubator coupling component 202a will be described.

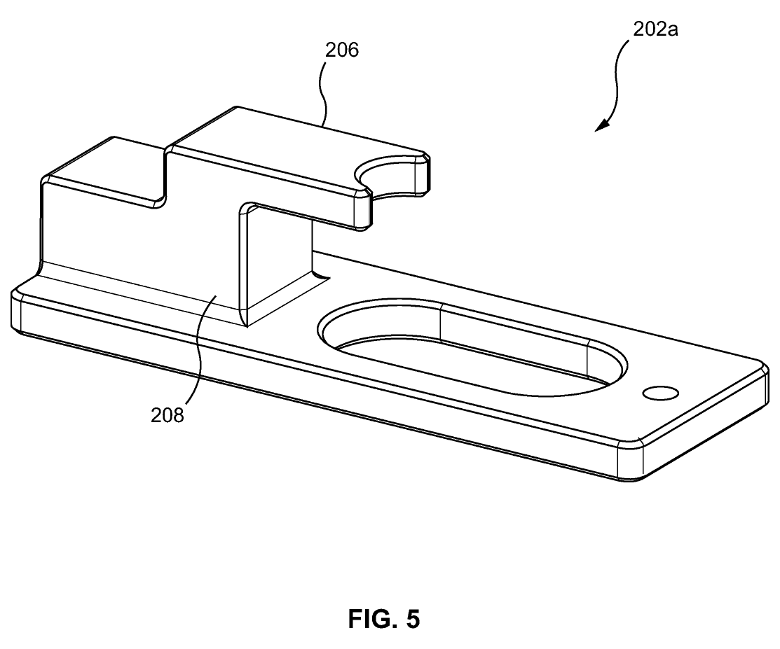

In this embodiment, the incubator coupling component 202a is configured to restrict movement upward, perpendicular to the support surface 104, as well as longitudinally along the support surface 104. As depicted in FIG. 5, the incubator coupling component 202a includes an arm 206 supported by a neck 208. The arm 206 is spaced apart from the support surface 104 by the neck 208 and extends substantially parallel to the support surface 104. When the incubator 10 is disposed on the support surface 104 and the incubator coupling assembly 200 is in the incubator coupled configuration, the arm 206 engages with a portion of the incubator 10, coupling the incubator 10 to the support surface 104 and restricting upward movement of the incubator 10. Simultaneously, the neck 208 impedes longitudinal movement of the incubator 10 along the support surface 104. It is contemplated that the configuration of the incubator coupling component 202a may vary in various embodiments while still coupling and uncoupling the incubator 10 to the support surface 104, and restricting movement in both an upwards and longitudinal direction.

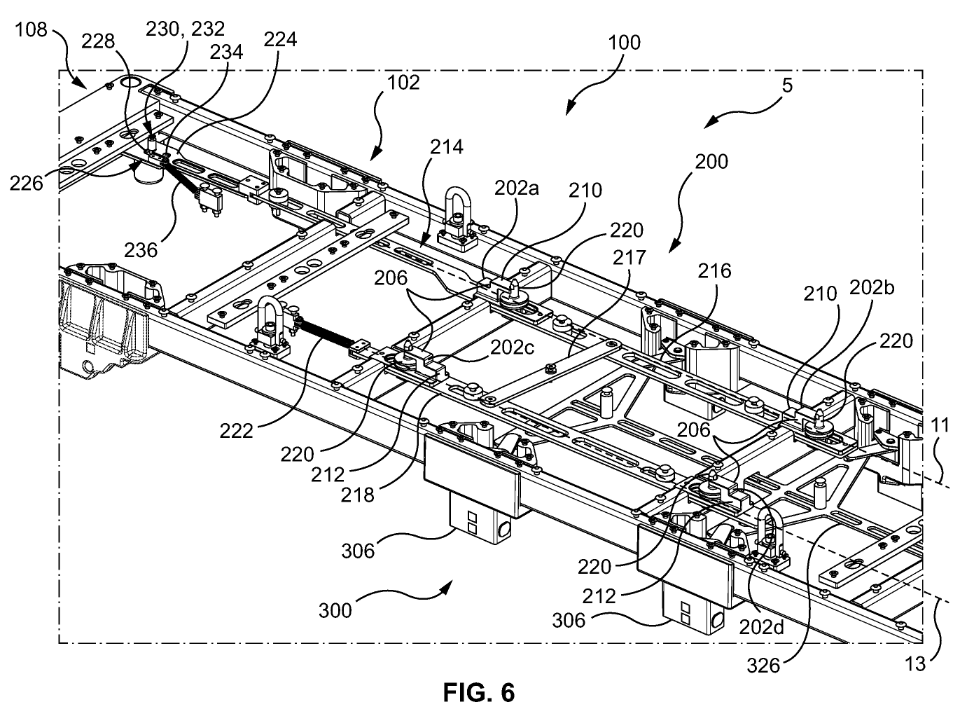

The four incubator coupling components 202a, 202b, 202c, 202d are arranged into two pairs (a first pair 210 and a second pair 212). Referring to FIG. 6, the first pair 210 of incubator coupling components 202a, 202b are spaced apart from each other and aligned longitudinally along a first longitudinal axis 11. Similarly, the second pair 212 of incubator coupling components 202c, 202d are spaced apart from each other and aligned longitudinally along a second longitudinal axis 13. The first longitudinal axis 11 and the second longitudinal axis 13 are parallel to one another, as well as to the support surface 104. The first longitudinal axis 11 is offset from the second longitudinal axis 13, such that the first pair 210 of incubator coupling components 202a, 202b are laterally spaced apart from the second pair 212 of incubator coupling components 202c, 202d.

The first pair 210 of incubator coupling components 202a, 202b are laterally aligned with the second pair 212 of incubator coupling components 202c, 202d. Specifically, incubator coupling components 202a and 202c are laterally aligned and incubator coupling components 202b and 202d are laterally aligned. When the incubator 10 is disposed on the support surface 104 and the incubator coupling assembly 200 is in the incubator coupled configuration, incubator coupling components 202a and 202c engage one side of the incubator 10, while incubator coupling components 202b and 202d engage the opposite side of the incubator 10.

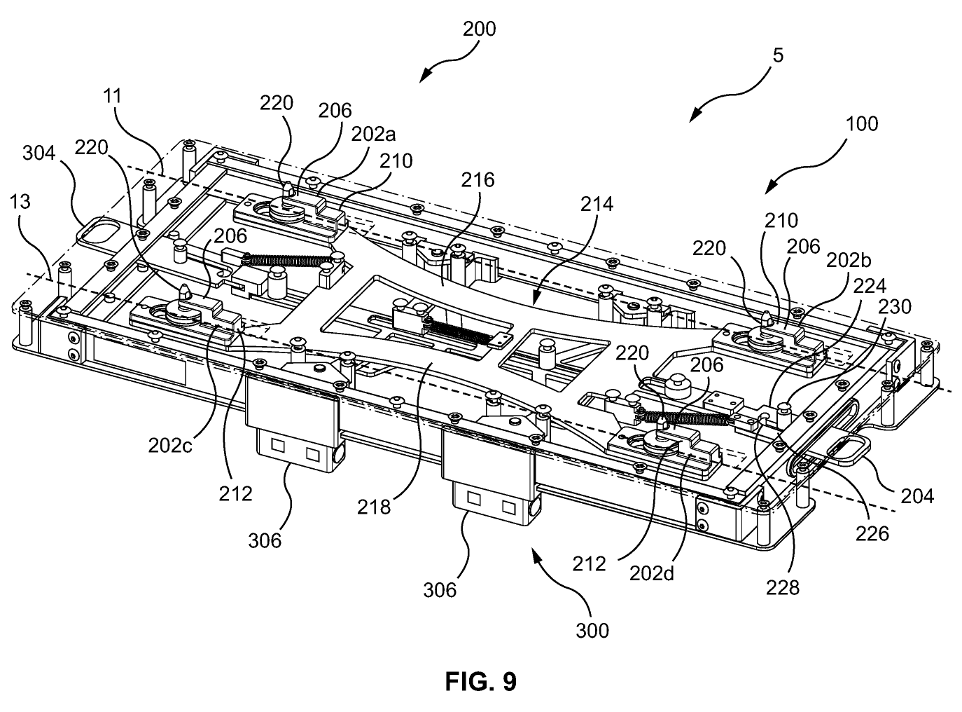

In this embodiment, the incubator coupling components 202a, 202b within the first pair 210 share the same orientation, and similarly, the incubator coupling components 202c, 202d within the second pair 212 share the same orientation. However, the orientation of the incubator coupling components 202a, 202b in the first pair 210 is opposite to that of the incubator coupling components 202c, 202d in the second pair 212. For instance, as depicted in FIGS. 3, 4, and 6, the arms 206 of the incubator coupling components 202a, 202b in the first pair 210 and the arms 206 of the incubator coupling components 202c, 202d extend in opposite directions, facing towards one another. It is contemplated that, in alternative embodiments such as depicted in FIG. 9, each pair 210, 212 of the incubator coupling components 202a, 202b, 202c, 202d may have the same orientation. In other words, the arms 206 of the incubator coupling components 202a, 202b, 202c, 202d face the same direction. In yet other embodiments, any other number of incubator coupling components 202 may be provided, which may be disposed on the body in any convenient manner for engaging with the incubator.

As described above, the incubator coupling components 202a, 202b, 202c, 202d are operably connected to the incubator actuator 204. Referring to FIGS. 6-8, the incubator coupling components 202a, 202b, 202c, 202d are operably connected to the incubator actuator 204 via an incubator linkage system 214. In this embodiment, the first pair 210 of incubator coupling components 202a, 202b are connected to a first linkage 216 of the incubator linkage system 214. The first linkage 216 is aligned with the first longitudinal axis 11, such that upon actuation the first pair 210 of incubator coupling components 202a, 202b move along the first longitudinal axis 11. The second pair 212 of incubator coupling components 202c, 202d are connected to a second linkage 218 of the incubator linkage system 214. The second linkage 218 is aligned with the second longitudinal axis 13, such that upon actuation the second pair 212 of incubator coupling components 202c, 202d move along the second longitudinal axis 13.

The first and second linkages 216, 218 are connected to one another. Upon actuation of the incubator actuator 204, the incubator coupling components 202a, 202b, 202c, 202d move simultaneously with one another. In this embodiment, the first and second linkages 216, 218 are pivotably connected to one another via a pivot linkage 217, such that upon actuation of the incubator actuator 204, the first linkage 216 moves opposite to the second linkage 218, thereby causing the first pair 210 of incubator coupling components 202a, 202b to move opposite from the second pair 212 of incubator coupling components 202c, 202d. As a result, the incubator coupling components 202a, 202b, 202c, 202d which engage the same side of the incubator 10 move towards and away from one another when coupling and uncoupling the incubator 10 respectively. In other words, when the incubator coupling assembly 200 moves to the incubator coupled configuration, the incubator coupling components 202a and 202c move towards one another to engage with the one side of the incubator 10 while the incubator coupling components 202b and 202d move towards one another to engage with the other side of the incubator 10. Similarly, when the incubator coupling assembly 200 moves to the incubator uncoupled configuration, the incubator coupling components 202a and 202c move away from one another, as do the incubator coupling components 202b and 202d.

In alternative embodiments, the incubator linkage assembly 214 may have different configurations. For example, as depicted in FIG. 9, the incubator linkage assembly 214 is configured to move all of the incubator coupling components 202a, 202b, 202c, 202d in the same longitudinal direction when actuated by the incubator actuator 204. The first linkage 216 is connected to the first pair 210 of incubator coupling components 202a, 202b. The first linkage 216 generally moves along the first longitudinal axis 11. The second linkage 218 is connected to the second pair 212 of incubator coupling components 202c, 202d. The second linkage 218 generally moves along the second longitudinal axis 13. Unlike the previously described embodiment, the first linkage 216 and the second linkage 218 are not pivotally connected. Instead, the first longitudinal both the first and second linkages 216, 218 move in unison along the first longitudinal axis 11 and the second longitudinal axis 13 respectively.

It is noted that while the incubator coupling components 202a, 202b, 202c, 202d are described as being arranged and moving along the first and second longitudinal axes 11, 13, alternative configurations are possible. For example, in alternative embodiments, the incubator coupling components 202a, 202b, 202c, 202d may be arranged and operate along lateral or diagonal axes.

With reference to FIGS. 6-8, the incubator coupling assembly 200 further includes an incubator coupling biasing member 222 for biasing the incubator coupling assembly 200 towards the incubator coupled configuration. In this embodiment, the incubator coupling biasing member 222 is a spring connected to the second linkage 218. The incubator coupling biasing member 222 may comprise any other type of biasing member. It is contemplated that the incubator coupling biasing member 222 may be connected to the first linkage 216. It is further contemplated that the incubator coupling assembly 200 may include any number of incubator coupling biasing members 222 or may be omitted.

As depicted in FIGS. 3, 4, and 6, the incubator coupling assembly 200 further includes a positioning member 220 to facilitate accurate positioning of the incubator 10 onto the support surface 104, thereby ensuring proper engagement and coupling of the incubator coupling components 202a, 202b, 202c, 202d. In this embodiment, the incubator coupling assembly 200 includes four positioning members 220, configured as pins 220. The pins 220 are positioned to align with the incubator coupling components 202a, 202b, 202c, 202d along the first and second longitudinal axes 11, 13. Specifically, two pins 220 are positioned along the first longitudinal axis 11, with one pin 220 being proximate to the incubator coupling component 202a and the other pin 220 being proximate to the incubator coupling component 202b. Similarly, the remaining two pins 220 are positioned along the second longitudinal axis 13, with one pin 220 being proximate to the incubator coupling component 202c and the other pin 220 being proximate to the incubator coupling component 202d. It is contemplated that the positioning of the pins 220 may vary in various embodiments.

The pins 220 are removably connected to the support surface 104 but may also be integrally formed in other embodiments. The pins 220 extend vertically from the support surface 104 to engage with the incubator 10 when the incubator 10 is positioned on the support surface 104. The pins 220 guide the incubator 10 into the proper position on the support surface 104, as well as limit any unintended movement along the support surface 104. It is contemplated that any number of positioning members 220 may be implemented. It is also contemplated that instead of pins, the positioning members 220 may comprise openings configured to receive protruding parts of the incubator 10. Other configurations of the positioning members 220 are within the scope of the present technology. Alternatively, the positioning members 220 may be omitted.

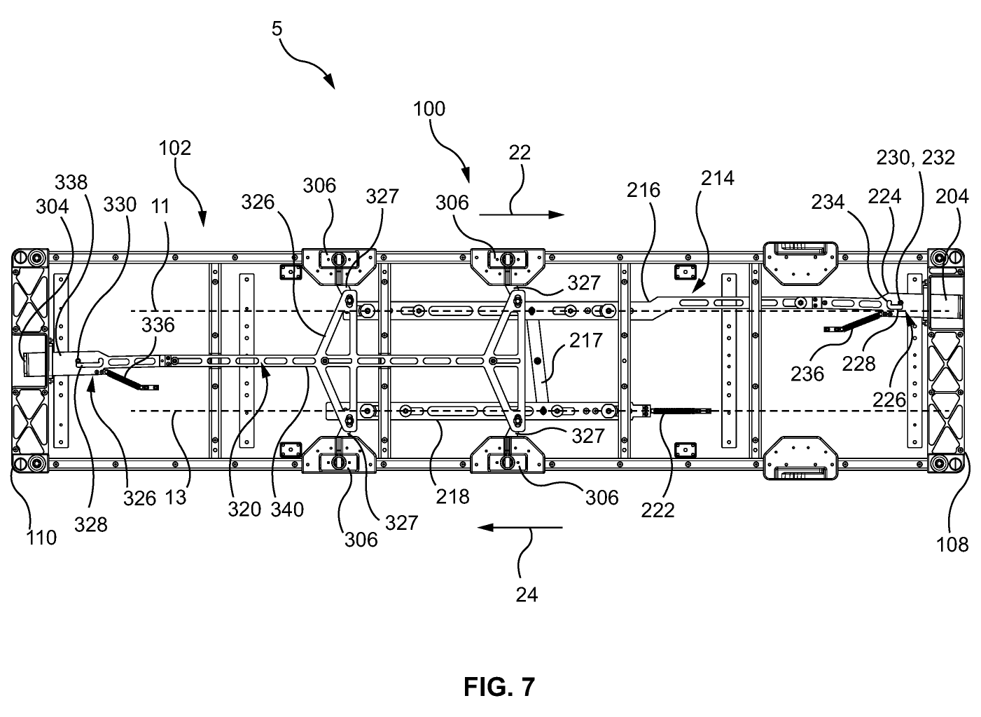

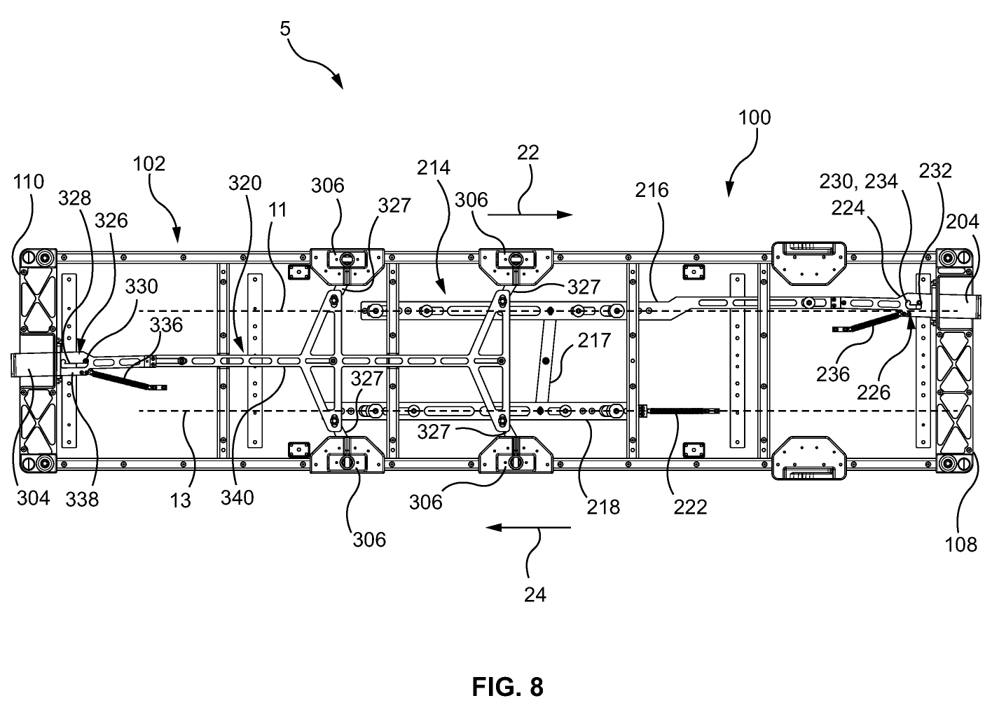

With reference to FIGS. 7 and 8, the incubator actuator 204 is positioned at one end 108 of the incubator interface 100. In this embodiment, depending on how the incubator interface 100 is oriented and coupled to the stretcher 12, the incubator actuator 204 is located at either a foot 18 or a head 20 of the stretcher 12. This may provide ready access to the user who may be pushing or pulling the stretcher 12 from a corresponding end of the stretcher 12. It is noted that, in other embodiments, positioning of the incubator actuator 204 may vary. For example, the incubator actuator 204 may be positioned along a side of the incubator interface 100.

In this embodiment, the incubator actuator 204 is an incubator handle 204 connected to the first linkage 216 via an incubator actuator arm 224. The incubator handle 204 and the incubator actuator arm 224 are positioned and moved along the same plane as the incubator linkage assembly 214. It is contemplated that, in other embodiments, the incubator actuator 204 may be designed differently. For example, the incubator actuator 204 may be a quick-release button or a foot pedal.

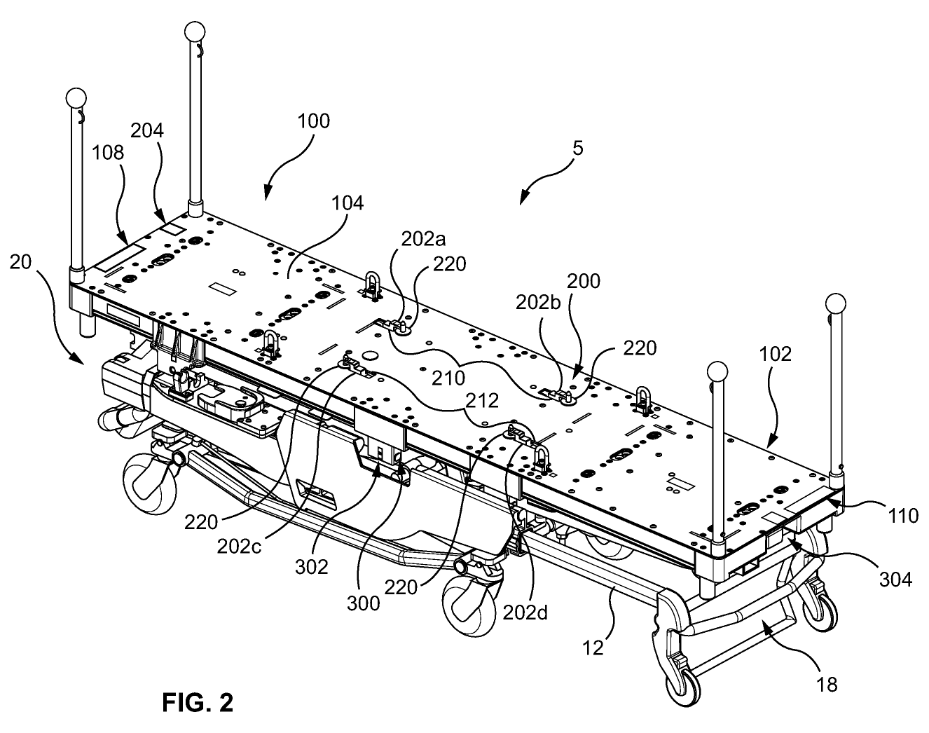

As described above, actuation of the incubator handle 204 moves the incubator coupling assembly 200 between the incubator coupled configuration (as depicted in FIG. 2) and the incubator uncoupled configuration (as depicted in FIG. 3). In this embodiment, moving the incubator handle 204 in a direction 22 away from the body 102 shifts the incubator coupling assembly 200 to the incubator uncoupled configuration. Specifically, this action moves the first linkage 216 in the same direction 22, causing the incubator coupling components 202a, 202b to also move in the same direction 22. Simultaneously, the movement of the first linkage 216 pivots the pivot linkage 217, resulting in the second linkage 218 moving in the opposite direction 24. This causes the incubator coupling components 202c, 202d to also move in the opposite direction 24. Conversely, when the incubator handle 204 is moved towards the body 204 in the direction 24, the incubator coupling assembly 200 moves towards the incubator coupled configuration.

Thus, the incubator coupling assembly 200 can be easily and efficiently actuated between the incubator coupled and uncoupled configurations. This enables the user to quickly couple and uncouple the incubator 10 from the incubator interface 100 through simple actuation of the incubator handle 204 by the user. Advantageously, single handed operation is achievable.

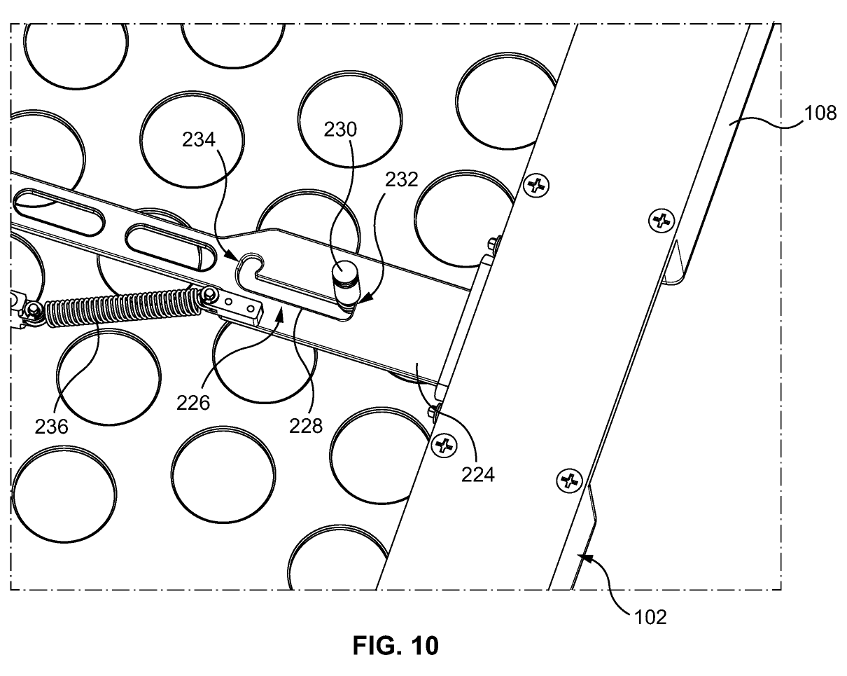

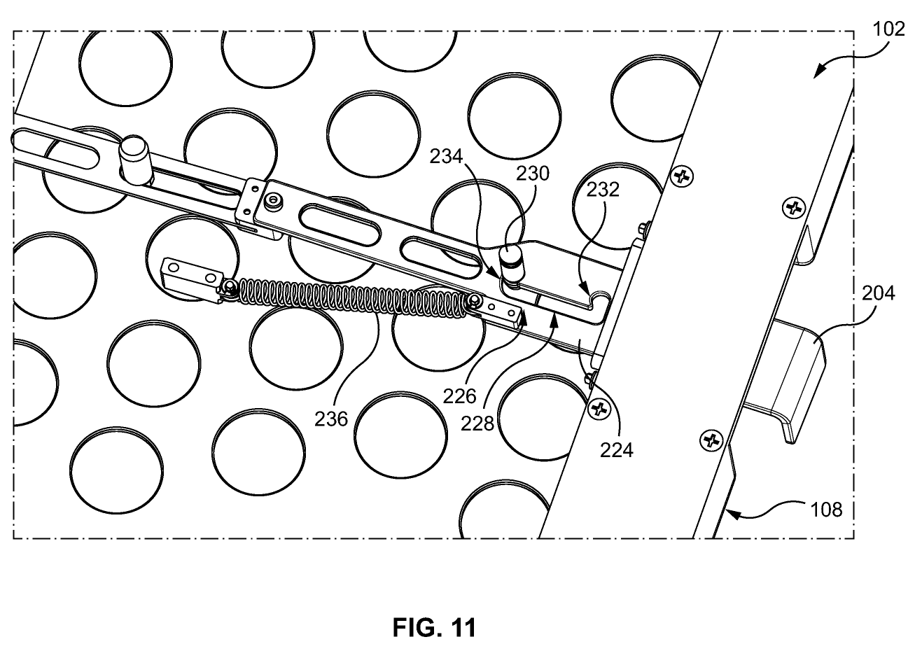

As depicted in FIGS. 10 and 11, the incubator coupling assembly 200 further includes an incubator retention mechanism 226 for retaining the incubator coupling assembly 200 in either the incubator coupled configuration or the incubator uncoupled configuration. In this embodiment, the incubator retention mechanism 226 includes a retention groove 228 and a retention pin 230. Specifically, the retention groove 228 is defined in the incubator actuator arm 224. The retention pin 230 is positioned on an underside of the support surface 104 and slidably received in the retention groove 228. The retention groove 228 is C-shaped, with one end 232 of the retention groove 228 corresponding to the incubator coupling assembly 200 being in the incubator coupled configuration (as depicted in FIG. 10) and the other end 234 corresponding to the incubator coupling assembly 200 in the incubator uncoupled configuration (as depicted in FIG. 11). It is noted that the retention groove 228 may be shaped differently in various embodiments, for example an S-shaped groove.

The incubator coupling assembly 200 further includes an incubator retention biasing member 236 for biasing the incubator retention mechanism 226. Specifically, in this embodiment, the incubator retention biasing member 236 is a spring 236 which biases the incubator actuator arm 224, guiding the incubator actuator arm 224 to position the retention pin 230 into one of the ends 232, 234 of the retention groove 228. Other types of biasing members are within the scope of the present technology.

It is contemplated that, in alternative embodiments, the incubator retention mechanism 226 and/or the incubator retention biasing member 236 may be omitted.

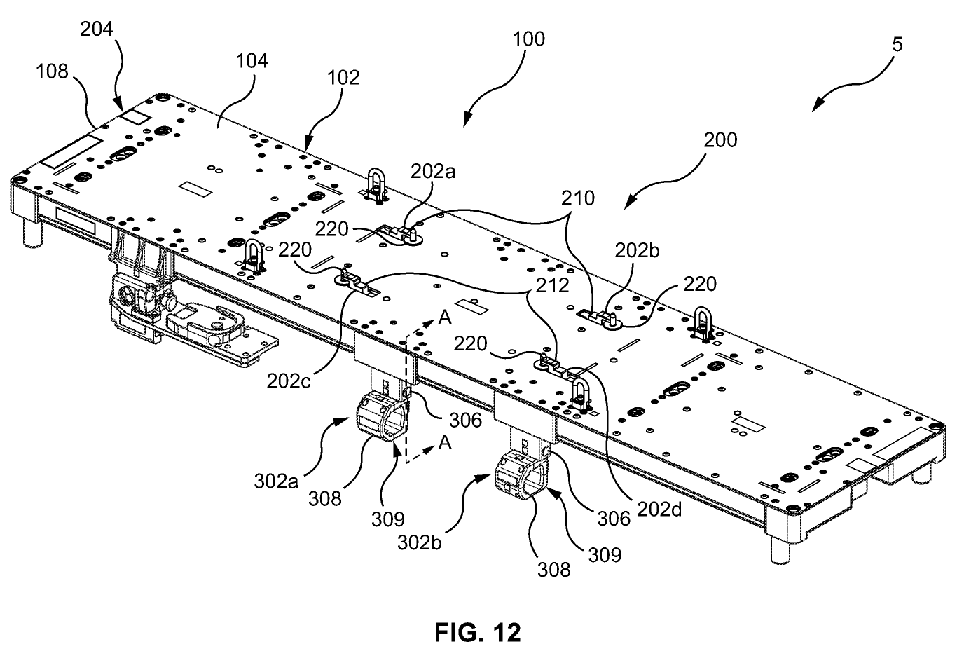

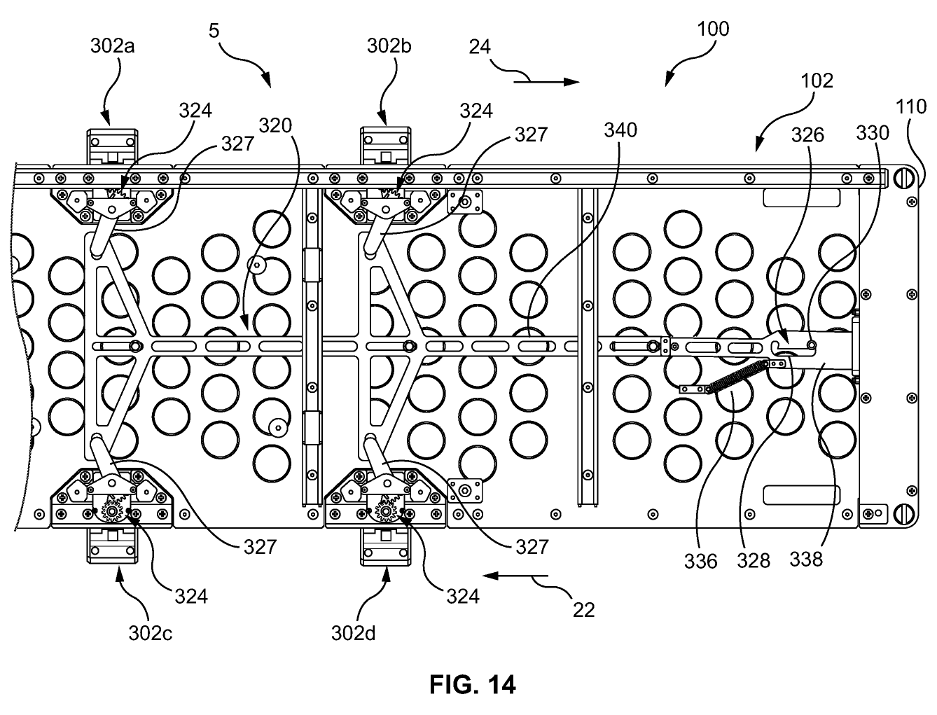

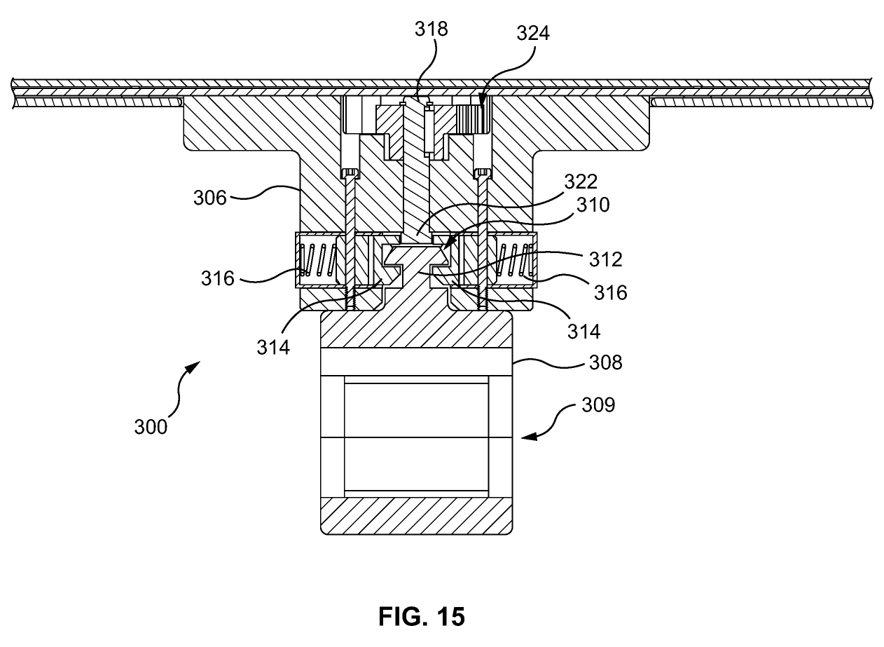

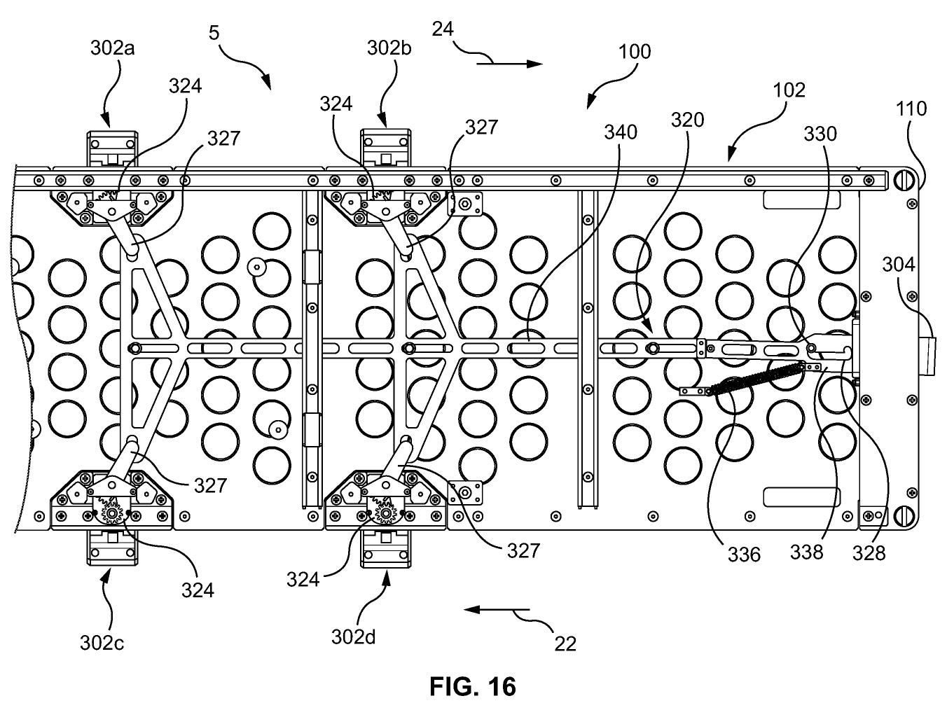

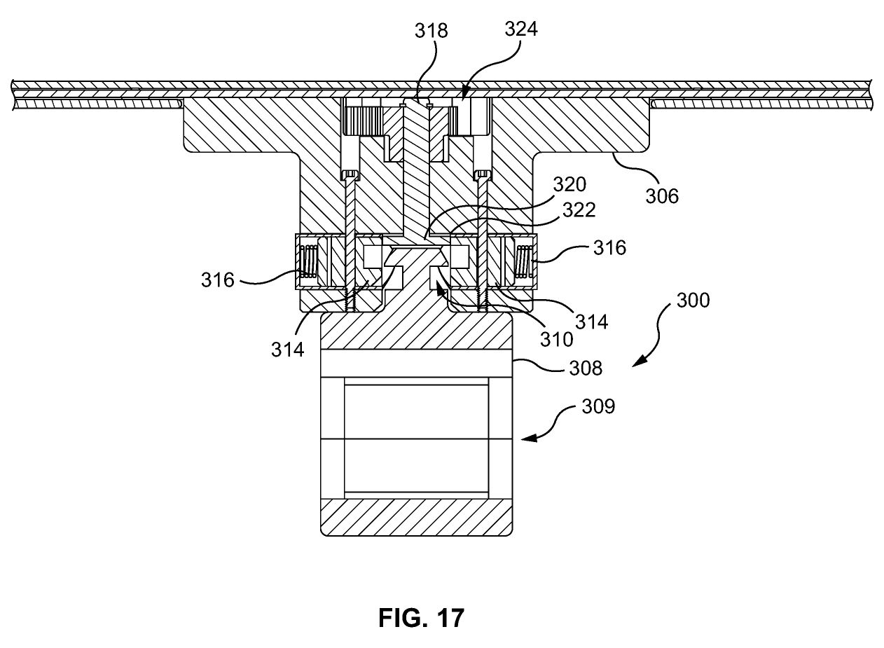

With reference to FIGS. 12-17, the transport coupling assembly 300 of the system 5 will be described in detail. As described above, the transport coupling assembly 300 is moveable between the transport coupled configuration (as depicted in FIGS. 14 and 15) and the transport uncoupled configuration (as depicted in FIGS. 16 and 17). The transport coupling assembly 300 includes a transport coupling component 302 for removably coupling the body 102 to the stretcher 12. The transport coupling assembly 300 further includes a transport actuator 304 operably connected to the transport coupling component 302 to actuate the transport coupling component 302 to selectively couple the body 102 of the incubator interface 100 to the stretcher 12.

In this embodiment, the transport coupling assembly 300 includes four transport coupling components 302a, 302b, 302c, 302d. Two transport coupling components 302a, 302b are positioned on one side of the incubator interface 100, while the other two transport coupling components 302c, 302d positioned on the other side of the incubator interface 100. It is contemplated that the number of transport coupling components 302 is not limiting, and in alternative embodiments, the transport coupling assembly 300 may include any number of transport coupling components 302. Each of the transport coupling components 302a, 302b, 302c, 302d extend below the body 102, however this may vary in other embodiments. It is noted that each of the transport coupling components 302a, 302b, 302c, 302d have the same configuration, and thus for clarity, only the transport coupling component 302a will be described.

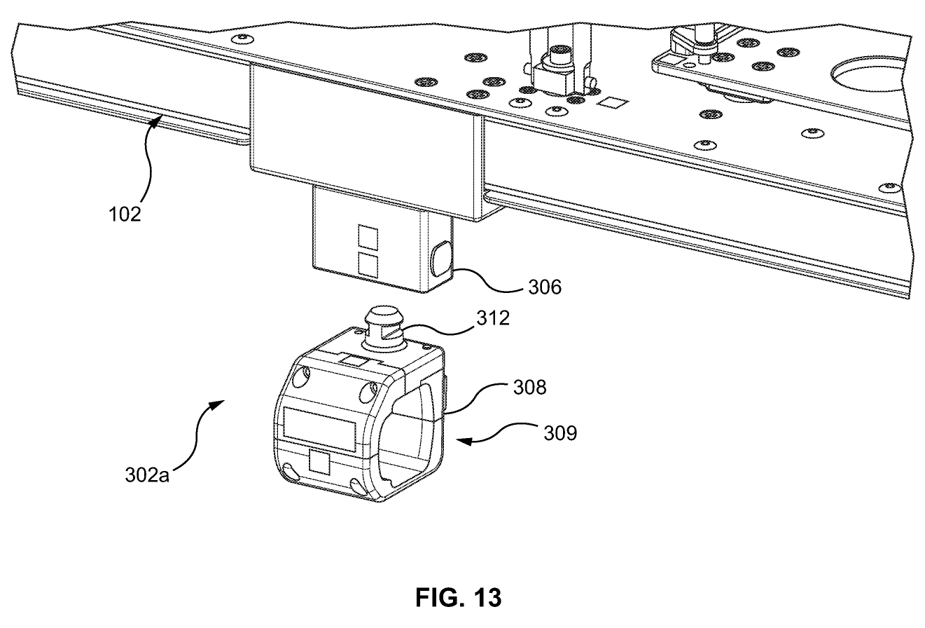

As depicted in FIGS. 13, 15, and 17, the transport coupling component 302a includes a female coupling component 306 and a male coupling component 308. In this embodiment, the female coupling component 306 is connected to the body 102 of the incubator interface 100 while the male coupling component 308 is removably connected to the stretcher 12. The male coupling component 308 is removably received in the female coupling component 306 to couple the incubator interface 100 to the stretcher 12. It is contemplated that, in other embodiments the male coupling component 308 may be connected to the body 102 while the female coupling component 306 may be removably connected to the stretcher 12.

The male coupling component 308 includes a clamp portion 309 configured to securely clamp around a portion of the stretcher 12. The male coupling component 308 further includes a stud 312 extending upward from a top surface of the clamp portion 309. The incubator interface 100 is moved vertically downwards onto the stretcher such that the stud 312 is received in and retained by the female coupling component 306 of the incubator interface 100, described in detail below.

It is contemplated that, in alternative embodiments, the configuration of the male coupling component 308 may vary to accommodate different patient transport devices 12. For example, as shown in FIGS. 18 and 19, the incubator interface 100 may be connected to an air transport cot 13. As such, the male coupling component 308 includes two clamp portions 309a, 309b configured to clamp a portion of the air transport cot 13. The male coupling component 308 further includes extensions 311a, 311b extending from the clamp portions 309a, 309b, respectively. The studs 312a, 312b extend upward from the extensions 311a, 311b to be removably received and retained by the female coupling component 306 of the incubator interface 100, thereby coupling the incubator interface 100 to the air transport cot 13.

The female coupling component 306 defines a channel 310 configured to receive the stud 312 of the male coupling component 308. As depicted in FIGS. 15 and 17, the female coupling component 306 further includes a pair of engagement arms 314. The engagement arms 314 are configured to move towards and away from one another. Specifically, in this embodiment, the engagement arms 314 move towards one another to engage opposing sides of the stud 312 when the transport coupling assembly 300 is in the transport coupled configuration (as depicted in FIG. 17). When engaged with the stud 312, the engagement arms 314 obstruct withdrawal of the stud 312 from the channel 310. This prevents inadvertent removal of the male coupling component 308 from the female coupling component 306, thus preventing inadvertent removal of the incubator interface 100 from the stretcher 12. The engagement arms 314 move away from one another to release the stud 312 when in the transport uncoupled configuration (as depicted in FIG. 15), allowing the male coupling component 308 to be removed from the female coupling component 306. Consequently, as the user lifts the incubator interface 100 upward, the male coupling component 308 remains removably connected to the stretcher 12 while the female coupling component 306 is moved upwards with the incubator interface 100, thereby uncoupling the incubator interface 100 from the stretcher 12.

Thus, as the user lifts the incubator interface 100 upwards, the male coupling component 308 remains removably coupled to the stretcher 12 while the female couple component 306 is moved away from the male coupling component, thereby removing the incubator interface 100 from the stretcher 12.

In this embodiment, the female coupling component 306 further includes a pair of engagement arm biasing members 316, with each engagement arm biasing member 316 being operably connected to a respective engagement arm 314. The engagement arm biasing members 316 are springs configured to bias the engagement arms 314 towards one another. Thus, the transport coupling assembly 300 is biased towards the coupled configuration. Other types of engagement arm biasing members 316 are within the scope of the present technology.

While two engagement arms 314 and two engagement arm biasing members 316 have been described, it is contemplated that the number of engagement arms 314 and engagement arm biasing members 316 may vary in various embodiments. It is further contemplated that the engagement arms 314 and/or engagement arm biasing members 316 may be omitted in other embodiments. For example, in some embodiments the male and female coupling components 306, 308 may have a snap-fit connection.

The female coupling component 308 further includes a rotatable rod 318 operably connected to the transport actuator 304 via a transport linkage assembly 320, described in detail below. The rod 318 is operably connected to the pair of engagement arms 314 such that rotation of the rod 318 in a first rotational direction moves the engagement arms 314 away from one another, and rotation of the rod 318 in a second, opposite, rotational direction moves the engagement arms 314 towards one another. In this embodiment, the rod 318 is T-shaped, such that ends of a top bar 322 of the rod 318 engage with the engagement arms 314. Specifically, when the transport coupling assembly 300 is in the transport uncoupled configuration (as depicted in FIG. 17), the ends of the top bar 322 push the engagement arms 314 away from one another. When the transport coupling assembly 300 is in the transport coupled configuration (as depicted in FIG. 18), the top bar 322 is rotated such that the ends of the top bar 322 no longer engage the engagement arms 314, allowing the engagement arms 314 to move towards one another.

The female coupling component 308 further includes a gear assembly 324 operably connected to the rod 318 for translating linear movement of the transport linkage assembly 320 and transport actuator 304 to rotational movement of the rod 318, as described in detail below.

Referring to FIGS. 14-17, the system 5 further includes the transport linkage assembly 320, which will now be described in detail. As described above, the rod 318 is operably connected to the transport actuator 304 via the transport linkage assembly 320. In this embodiment, the transport linkage assembly 320 is configured to move all the transport coupling components 302a, 302b, 302c, 302d simultaneously between the transport coupled configuration and the transport uncoupled configuration.

The transport linkage assembly 320 includes a linkage frame 340. The linkage frame 340 connects to pivoting arms 327. The pivoting arms 327 are operably connected to a respective gear assembly 324 of the female coupling components 306 of each of the transport coupling components 302a, 302b, 302c, 302d.

The transport actuator 304 is positioned at the opposite end 110 of the incubator interface 100 from the incubator handle 204. Depending on how the incubator interface 100 is oriented and coupled to the stretcher 12, the transport actuator 304 is positioned at one of the foot 18 or the head 20 of the stretcher 12 while the incubator actuator 204 is positioned at the other one of the foot 18 or the head 20 of the stretcher 12. It is contemplated that the positioning of the incubator actuator 304 may vary in various embodiments.

In this embodiment, the transport actuator 304 is a transport handle 304 connected to the linkage frame 340 via a transport actuator arm 338. The transport handle 304 and the transport actuator arm 338 are positioned and moved along the same plane as the transport linkage assembly 320. It is contemplated that, in other embodiments, the transport actuator 304 may be designed differently. For example, the transport actuator 304 may be a quick-release button.

As described above, actuation of the transport handle 304 moves the transport coupling assembly 300 between the transport coupled configuration (as depicted in FIGS. 14 and 15) and the transport uncoupled configuration (as depicted in FIGS. 16 and 17). In this embodiment, moving the transport handle 304 in the direction 24 away from the body 102 shifts the transport coupling assembly 300 to the transport uncoupled configuration. Specifically, this action moves the linkage frame 340 in the same direction 24 which rotates the pivoting arms 327. This rotation drives the gear assembly 324 of the female coupling components 306 each of the transport coupling components 302a, 302b, 302c, 302d. Within each of the female coupling components 306, the rod 318, connected to the gear assembly 324, rotates causing the ends of the top bar 322 to engage the pair of engagement arms 314. This pushes the engagement arms 314 apart from one another allowing the stud 312 of the male coupling component 308 to be removed from the channel 310, thereby uncoupling the incubator interface 100 from the stretcher 12. Conversely, when the transport handle 304 is moved in the direction 22, towards the body 102 of the incubator interface 100, the gear assembly 324 drives rotation of the rod 318 in the opposite direction. As a result, the ends of the top bar 322 no longer engage the engagement arms 314. The engagement arms 314 move towards one another, engaging the stud 312 of the male coupling component 308 within the channel 310, thereby coupling the incubator interface 100 to the stretcher 12.

Referring to FIGS. 7 and 8, as the incubator handle 204 and the transport handle 304 are positioned at opposite ends 108, 110 of the incubator interface 100, they move in opposite directions to shift the incubator coupling assembly 200 and the transport coupling assembly 300 between the respective coupled and uncoupled configurations. In this embodiment, actuating the incubator handle 204 in direction 22 to move the incubator coupling assembly 200 to the incubator uncoupled configuration, while actuating the transport handle 304 in the opposite direction 24 shifts the transport coupling assembly 300 to the transport uncoupled configuration. Conversely, actuating the incubator handle 204 in direction 24 and the transport handle 304 in the opposite direction 22 moves the incubator and transport coupling assemblies 200, 300 back to the respective coupled configurations. It is noted that, in this embodiment, the incubator handle 204 and the transport handle 304 operate in parallel directions to one another, as well as to the first and the second longitudinal axes 11, 13.

In this embodiment, the transport actuator 304 includes a transport retention mechanism 326 for retaining the transport coupling assembly 300 in either the transport coupled configuration or the transport uncoupled configuration. In this embodiment the transport retention mechanism 326 includes a retention groove 328 defined in the transport actuator arm 338 and a retention pin 330 extending from the underside of the support surface 104. It is noted that the transport retention mechanism 326 is configured similarly to the incubator retention mechanism 226, and therefore will not be described in further detail.

The transport coupling assembly 300 further incudes a transport retention biasing member 336 for biasing the transport retention mechanism 326. It is noted that, the transport retention biasing member 336 is configured similarly to the incubator retention biasing member 236, and therefore will not be described in further detail.

It is contemplated that, in alternative embodiments, the transport retention mechanism 326 and/or the transport retention biasing member 336 may be omitted.

The described embodiments highlight several advantages of the functionality and adaptability of the incubator interface 100. In these embodiments, the incubator interface 100 is equipped with separate incubator coupling assembly 200, for coupling and uncoupling the incubator 10 to the incubator interface 100, and transport coupling assembly 300, for coupling and uncoupling the incubator interface 100 from the patient transport device 12, 13. This provides flexibility to the incubator interface 100, for example, allowing the user to uncouple the incubator 10 and/or associated neonatal medical equipment 16 from the incubator interface 100 without uncoupling the incubator interface 100 from the patient transport device 12, 13. This makes it easy for the user to adapt the incubator interface 100 to the specific needs of the patient. Additionally, when the incubator coupling assembly 200 and the transport coupling assembly 300 are in their respective coupled configurations, the incubator 10 is securely attached to the patient transport device 12, 13. This ensures that the incubator 10 remains stable and secured even when the patient transport device 12, 13 is jostled or suddenly stopped, providing safety for the neonate inside.

Additionally, the user can transfer the incubator interface 100 between different patient transport devices 12, 13 without needing to couple and uncouple the incubator 10 and/or associated neonatal medical equipment 16. For example, the user can uncouple the incubator interface 100 from a stretcher 12 designed specifically for ambulance transport and transfer the incubator interface 100 to a stretcher 12 designed specifically for in-hospital transport, or the incubator interface 100 can be transferred from a stretcher 12 to an air transport cot 13 for air transport, without needing to uncouple the incubator 10 and/or associated medical equipment 16 from the incubator interface 100. Moreover, the incubator 10 and/or associated neonatal medical equipment 16 can be uncoupled and removed from the incubator interface 100, which can, in turn, be uncoupled and removed from the patient transport device 12, 13. This enables the incubator interface 100 to be easily portable and conveniently stored when not in use.

Furthermore, the incubator coupling assembly 200 includes the incubator handle 204, and the transport coupling assembly 300 incudes the transport handle 304. The incubator handle 204 and the transport handle 304 are configured to allow for single-hand operation. This ensures that modulation of the incubator coupling assembly 200 and the transport coupling assembly 300 between the respective coupled and uncoupled configurations is easy, quick and efficient.

Modifications and improvements to the above-described embodiments of the present technology may become apparent to those skilled in the art. The foregoing description is intended to be exemplary rather than limiting. The scope of the present technology is therefore intended to be limited solely by the appended claims.

What is claimed is:

1. A system for connecting an incubator is to a patient transport device, the system comprising:
an incubator interface having:
a body having a support surface for supporting the incubator, the body defining a body plane;
an incubator coupling assembly moveable between a incubator coupled configuration, in which the incubator can be coupled to the body, and an incubator uncoupled configuration, in which the incubator can be removed from the body, the incubator coupling assembly comprising:
an incubator coupling component for removably coupling the incubator to the body; and
an incubator actuator operably connected to the incubator coupling component for actuating the incubator coupling component to selectively couple the incubator to the body; and
a transport coupling assembly movable between a transport coupled configuration, in which the body of the incubator interface can be coupled to the patient transport device, and a transport uncoupled configuration, in which the body can be removed from the patient transport device, the transport coupling assembly comprising:
a transport coupling component for removably coupling the body to the patient transport device; and
a transport actuator operably connected to the transport coupling component for actuating the transport coupling unit to selectively couple the body to the patient transport device.

2. The system of claim 1, wherein the incubator coupling component is configured to allow coupling and uncoupling of the incubator in a direction perpendicular to the body plane.

3. The system of claim 1, wherein the incubator actuator is moveable in a plane parallel to the body plane.

4. The system of claim 1, wherein the incubator coupling component is configured to prevent movement of the incubator in a direction substantially parallel to the body plane.

5. The system of claim 1, wherein the incubator coupling component is configured to move in a direction substantially parallel to the support surface between the incubator coupled and uncoupled configurations.

6. The system of claim 5, wherein the incubator coupling component includes an arm that is configured to engage with a portion of the incubator when the incubator is disposed on the support surface and when the incubator coupling assembly is moved into the incubator coupled configuration, the arm being spaced from the support surface of the body by a neck.

7. The system of claim 1, wherein the incubator coupling component comprises a plurality of incubator coupling components.

8. The system of claim 7, wherein the incubator coupling assembly is configured such that actuation of the incubator actuator causes the plurality of incubator coupling components to move simultaneously to selectively couple the incubator to the body.

9. The system of claim 7, wherein the incubator coupling assembly is configured such that actuation of the incubator actuator causes at least some of the plurality of incubator coupling components to move away from each other or towards each other.

10. The system of claim 7, wherein the incubator coupling assembly further comprises a linkage assembly for connecting the plurality of incubator coupling components to the incubator actuator.

11. The system of claim 7, wherein the plurality of incubator coupling components comprises:
a first pair of incubator coupling components longitudinally aligned with one another along a first longitudinal axis of the body; and
a second pair of incubator coupling components longitudinally aligned with one another along a second longitudinal axis of the body, the second longitudinal axis being substantially parallel to the first longitudinal axis.

12. The system of claim 11, wherein:
each incubator coupling component of the first pair of incubator coupling components have the same orientation as one another; and
each incubator coupling component of the second pair of incubator coupling components have the same orientation as one another.

13. The system of claim 12, wherein the first pair of incubator coupling components are oriented opposite to the second pair of incubator coupling components.

14. The system of claim 13, wherein:
the first pair of incubator coupling components are moveable relative to the body in a first direction along the first longitudinal axis; and
the second pair of incubator coupling components are moveable relative to the body in a second direction along the second longitudinal axis, the second direction being opposite to the first direction.

15. The system of claim 10, wherein the incubator linkage assembly comprises:
a first linkage configured to move substantially along the first longitudinal axis and connected to the first pair of incubator coupling components and the incubator actuator;
a second linkage configured to move substantially along the second longitudinal axis and connected to the second pair of incubator coupling components and the incubator actuator; and
the first linkage and the second linkage move opposite to one another responsive to actuation of the incubator actuator.

16. The system of claim 1, wherein the transport coupling component comprises:
a first transport coupling component connected to the body; and
a second transport coupling component removably connected to the first transport coupling component, wherein the second transport coupling component is configured to be removably connected to the patient transport device.

17. The system of claim 16, wherein the second transport coupling component is configured to move in an installation direction to removably couple with the first transport coupling component, the installation direction being perpendicular to the body plane.

18. The system of claim 16, wherein:
the first transport coupling component comprises a female coupling element; and
the second transport coupling component comprises a male coupling element.

19. The system of claim 18, wherein the first transport coupling component comprises:
a first engagement arm; and
a second engagement configured, the first and second engagement arms being configured to move to engage the male coupling element of the second transport coupling component.

20. The system of claim 1, wherein:
the incubator actuator moves in a first actuator direction to actuate the incubator coupling assembly to the incubator coupled configuration; and
the transport actuator moves in a second actuator direction to actuate the transport coupling assembly to the transport coupled configuration, the first actuator direction being opposite to the second actuator direction.
